(19) United States
(12) Patent Application Publication
(10) Pub. No.: US 2025/0233666 A1
(43) Pub. Date: Jul. 17, 2025

(54) DEVICES WITH OPTICAL-ELECTRICAL-OPTICAL CONVERTER

(71) Applicant: Telefonaktiebolaget LM Ericsson (publ), Stockholm (SE)

(72) Inventor: Stefan DAHLFORT, LOS GATOS, CA (US)

(73) Assignee: Telefonaktiebolaget LM Ericsson (publ), Stockholm (SE)

(21) Appl. No.: 18/853,717

(22) PCT Filed: May 2, 2022
(86) PCT No.: PCT/IB2022/054047

§ 371 Date: Oct. 2, 2024

(51) Int. Cl. H04B 10/40; G02B 6/42

(52) U.S. Cl. CPC H04B 10/40; G02B 6/4278

(57) ABSTRACT

In one embodiment, a pluggable device is described that is usable with a host network device. The pluggable device comprises a housing, and a host-side external optical interface at a first end of the housing to be removably inserted into a receptacle of the host network device. When the first end of the housing is in an inserted position, the host-side external optical interface is optically coupled with one or more optical components of the host network device. The pluggable device further comprises a line-side external optical interface at an opposing second end of the housing, and a bidirectional optical-to-electrical-to-optical (O-E-O) converter within the housing. The O-E-O converter is coupled between the host-side external optical interface and the line-side external optical interface.

### TECHNICAL FIELD

Embodiments describe herein relate to the field of networking devices; and more specifically, to devices having an optical-to-electrical-to-optical (O-E-O) converter that are usable with a network device.

### BACKGROUND ART

Network devices of various configurations (e.g., providing fixed or mobile access, or providing time-division multiplexing or packed-based transport) increasingly include optical pathways to connect with processor(s) of the network device. For example, a network device may include one or more processors (e.g., an electronic chip or integrated circuit (IC)) that perform various functions of the networking stack within the electrical domain, and may use front plate-pluggable devices to perform the electrical-to-optical (E-O) conversion and optical-to-electrical (O-E) conversion that supports optical connections with other network device(s).

With increasing data rates, it is increasingly complex and costly to drive the electrical signals to and from the electronic IC. One conventional approach includes arranging optical components as close as possible to the electronic IC, and using light-carrying media (such as optical fibers and optical waveguides) to carry optical signals between the electronic IC and the other network device(s). Another conventional approach includes integrating optical functions and the electrical functions within the same packaging (e.g., co-packaged optics), such that the IC includes optical signal interfaces. In such cases, an optical connection patch panel may be arranged at the front plate of the network device, which connects various internal light-carrying media with the cables from the other network device(s).

These conventional approaches are cost-effective only for relatively short transmission distances, as longer distance connections (e.g., intersite connections of 500 meters (m) to 2 kilometers (km) or more) typically require more complex optical functions that consume greater power than is available within the power envelope of the electronic IC with co-packaged optics. In some cases, an external transponder may be used to convert the optical signals from the network device to a format suitable for longer distance transmissions. The external transponder typically uses pluggable devices to connect to the network device and to connect to the other network device(s). In some cases, pluggable devices for the network device may provide optical amplification using erbium-doped fiber amplifiers (EDFAs) or semiconductor optical amplifiers (SOAs). However, while optical amplification can mitigate transmission losses to support longer transmission distances, optical amplification alone cannot mitigate degradation of the optical signals due to chromatic dispersion and other factors.

### SUMMARY

In one embodiment, a pluggable device is described that is usable with a host network device. The pluggable device comprises a housing, and a host-side external optical interface at a first end of the housing to be removably inserted into a receptacle of the host network device. When the first end of the housing is in an inserted position, the host-side external optical interface is optically coupled with one or more optical components of the host network device. The pluggable device further comprises a line-side external optical interface at an opposing second end of the housing, and a bidirectional optical-to-electrical-to-optical (O-E-O) converter within the housing. The O-E-O converter is coupled between the host-side external optical interface and the line-side external optical interface.

By including the O-E-O converter in the pluggable device, relatively longer transmission distances may be achieved without requiring an external transponder to be interposed between the host network device and a remote (line-side) network device. Further, using the O-E-O-enabled pluggable device, fewer (and/or smaller) pluggable devices may support the relatively few intersite connections needed from the host network device to remote network device(s).

In another embodiment, an optical device is described that is usable with a host network device. The optical device comprises a body, a host-side external interface to the body, and a line-side external interface to the body. The host-side external interface comprises a first external optical interface to couple with a first plurality of light-carrying media of the host network device, and an external electrical interface. The line-side external interface comprises a second external optical interface to couple with a remote network device via one or more light-carrying media. The optical device further comprises a bidirectional optical-to-electrical-to-optical (O-E-O) converter within the body and coupled between the first external optical interface and the second external optical interface. The O-E-O converter is to receive electrical power from the host network device via the external electrical interface.

By including the O-E-O converter in the optical device, relatively longer transmission distances may be achieved without requiring an external transponder to be interposed between the host network device and a remote (line-side) network device. Further, using the O-E-O-enabled optical device, fewer (and/or smaller) pluggable devices may support the relatively few intersite connections needed from the host network device to remote network device(s).

In another embodiment, a network device comprises a housing defining an interior volume, a plurality of receptacles extending from a surface of the housing into the interior volume, a plurality of host electrical connectors arranged at the plurality of receptacles, and one or more host optical connectors arranged at one or more optical-enabled receptacles of the plurality of receptacles. When a first type of pluggable device is received into an inserted position in any of the plurality of receptacles, an electrical connector of the first type of pluggable device is electrically coupled with a corresponding host electrical connector of the plurality of host electrical connectors. When a second type of pluggable device is received into the inserted position in any of the one or more optical-enabled receptacles: (1) an electrical connector of the second type of pluggable device is electrically coupled with a corresponding host electrical connector of the plurality of host electrical connectors, and (2) an optical connector of the second type of pluggable device is optically coupled with a corresponding host optical connector of the one or more host optical connectors.

By including the host electrical connectors and host optical connector(s) at the optical-enable receptacle(s), the network device supports connections with different types of pluggable devices, including conventional pluggable devices as well as the O-E-O-enabled pluggable devices described herein. In this way, the network device may be used to achieve relatively longer transmission distances without requiring an external transponder to be interposed between the host network device and a remote (line-side) network device.

### BRIEF DESCRIPTION OF THE DRAWINGS

The invention may best be understood by referring to the following description and accompanying drawings that are used to illustrate embodiments of the invention. In the drawings:

FIG. 1A illustrates an exemplary pluggable device usable with a host network device, according to one or more embodiments.

FIG. 1B illustrates a block diagram of the exemplary pluggable device having a bidirectional optical-to-electrical-to-optical (O-E-O) converter, according to one or more embodiments.

FIG. 1C illustrates a host-side external optical interface and a host-side external optical interface integrated into a single host-side connector, according to one or more embodiments.

FIG. 1D illustrates a host-side external optical interface and a host-side external optical interface included in separate host-side connectors, according to one or more embodiments.

FIG. 2A illustrates a block diagram of an exemplary optical-to-electrical (O-E) converter, according to one or more embodiments.

FIG. 2B illustrates a block diagram of an exemplary electrical-to-optical (E-O) converter, according to one or more embodiments.

FIG. 2C illustrates a block diagram of an exemplary transmitter, according to one or more embodiments.

FIG. 2D illustrates a block diagram of an exemplary receiver, according to one or more embodiments.

FIG. 3A illustrates an exemplary network device with an exemplary pluggable device in an uninserted position, according to one or more embodiments.

FIG. 3B illustrates an exemplary network device with an exemplary pluggable device in an inserted position, according to one or more embodiments.

FIG. 4 illustrates a block diagram of an exemplary network device coupled with a remote network device, according to one or more embodiments.

FIG. 5 illustrates an exemplary optical device having a pigtail extending to a host-side external interface, according to one or more embodiments.

FIG. 6 illustrates an exemplary optical device using connectorized optical cables to couple with a network device, according to one or more embodiments.

### DETAILED DESCRIPTION

Embodiments are generally directed to an O-E-O-enabled network device, as well as an associated O-E-O-enabled pluggable device and an O-E-O-enabled optical device. In some embodiments, the O-E-O-enabled pluggable device includes a host-side external optical interface that optically couples with one or more optical components of a host network device, which may not be natively O-E-O enabled, to form the O-E-O-enabled network device when the O-E-O-enabled pluggable device is in an inserted position in a receptacle of the host network device. The O-E-O-enabled pluggable device also includes a line-side external optical interface, and an O-E-O converter coupled between the host-side external optical interface and the line-side external optical interface. The forming the optical coupling with the one or more optical components of the host network device enables the optical coupling of the host network device with the O-E-O converter, which in turn enables the O-E-O capability of the O-E-O-enabled network device.

In some cases, a connection needs to be established between the host network device and another network device that is sufficiently distant (e.g., 500 meters (m) to 2 kilometers (km) or more) such that the connect is considered a connection to “remote network device.” In some cases, the connection may be about 20 km, 40 km, 80 km, or more. Such a connection may be considered an “intersite connection” where the host network device and the remote network device are located at distinct sites. Each site may be defined using any number of criteria: by shared resources (e.g., a site receiving electrical power from a particular electrical substation), by the optical connections used between network devices at a particular site (e.g., single-mode optical signals instead of longer-haul formats), and so forth.

By including the O-E-O converter in various embodiments of the O-E-O-enabled pluggable device, the O-E-O-enabled optical device, and/or the O-E-O-enabled network device, relatively longer transmission distances may be achieved to a remote network device (e.g., supporting intersite connections between the host network device and the remote network device of 500 m to 2 km or more) without requiring an external transponder to be interposed between the network devices. Such embodiments avoid the need to co-locate with the host network device an external transponder (a separate second network device) to support longer transmission distances, which is advantageous for many reasons (e.g., purchase expense, operating expense such as deployment, operations, failures, and/or maintenance, space requirements, etc.).

Further, a given host network device typically has several receptacles (e.g., in the range of 4-16 or more), but in common deployment scenarios only a small number of receptacles (e.g., 1 or 2) are used to establish intersite connections (and thus require use of an external transponder or O-E-O-enabled pluggable device) since most of the receptacles will be used to establish intrasite connections (and thus NOT require use of an external transponder or O-E-O-enabled pluggable device). The use of O-E-O-enabled pluggable devices has the advantages of deploying devices tailored to requirements (e.g., that match the number of intersite connections needed). In contrast, an external transponder typically supports a fixed number of intersite connections, and thus presents the problem of having to try to choose an external transponder that supports the number of intersite connections currently needed (and perhaps the number estimated to be needed in the future). This results in inefficiencies, such as part of the external transponder's ability going unused (for at least part of the time of its deployment) and/or the expense associated with replacing an external transponder with one with a greater ability to support an increased demand at a given site for intersite connections.

Further, by employing short-reach optics at the host network device, the host network device may generally be limited to a single implementation of the optical circuitry, and the challenge of longer-distance connections is addressed by external transponders. Using the longer-reach optics, such as those provided by the O-E-O-enabled pluggable devices, different implementations of the optical circuitry may be employed at the host network device, e.g., tailored to how many longer-reach optical ports are needed, the specific transmission distances, and so forth.

In some such embodiments, the intersite connections may be established without requiring EDFAs to perform optical amplification of the optical signal(s) received from the host network device (which in some cases may be generated by co-packaged optics included in the host network device). This has advantages over external transponders that use optical amplifiers such as EDFAs, since EDFAs are relatively limited in their operation, amplifying at a particular wavelength (e.g., about 1.55 um) that does not correspond to the wavelengths typically used by the co-packaged optics (e.g., about 1.30 um or less), and compatible only with single-mode optical fibers. Further, as discussed above, optical amplification can mitigate transmission losses but optical amplification alone cannot mitigate degradation of the optical signals due to chromatic dispersion and other factors.

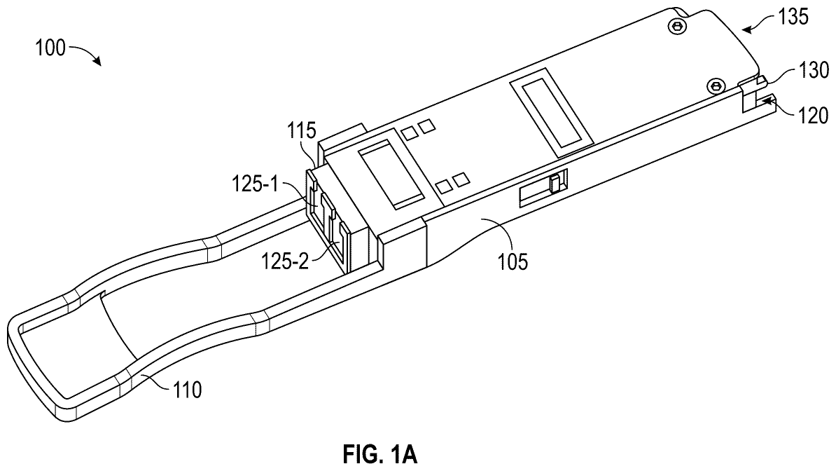

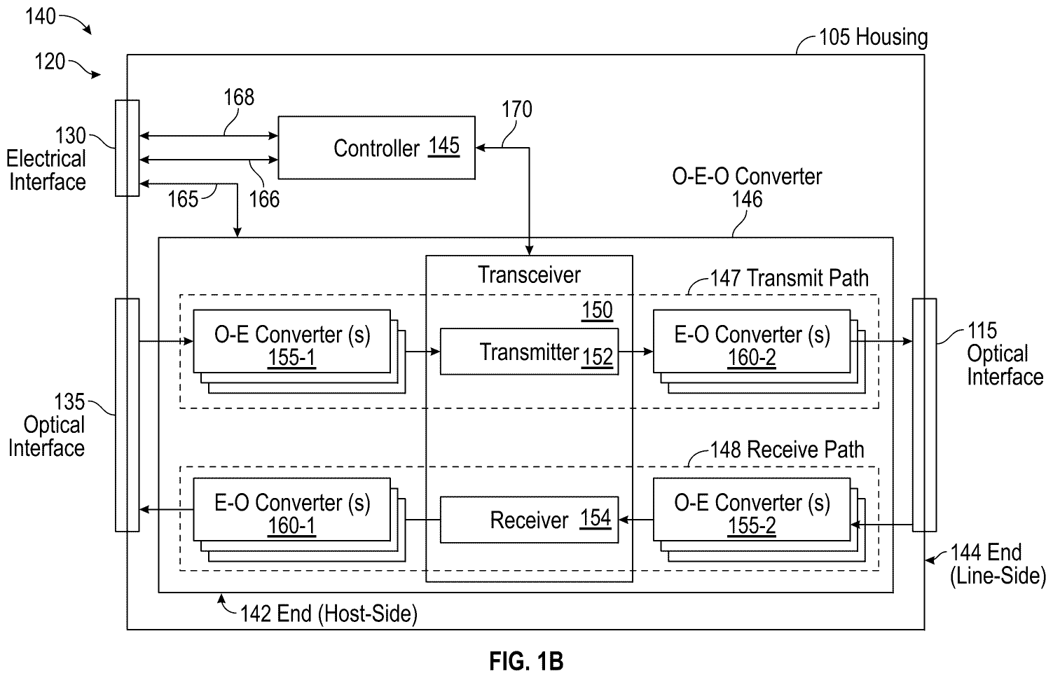

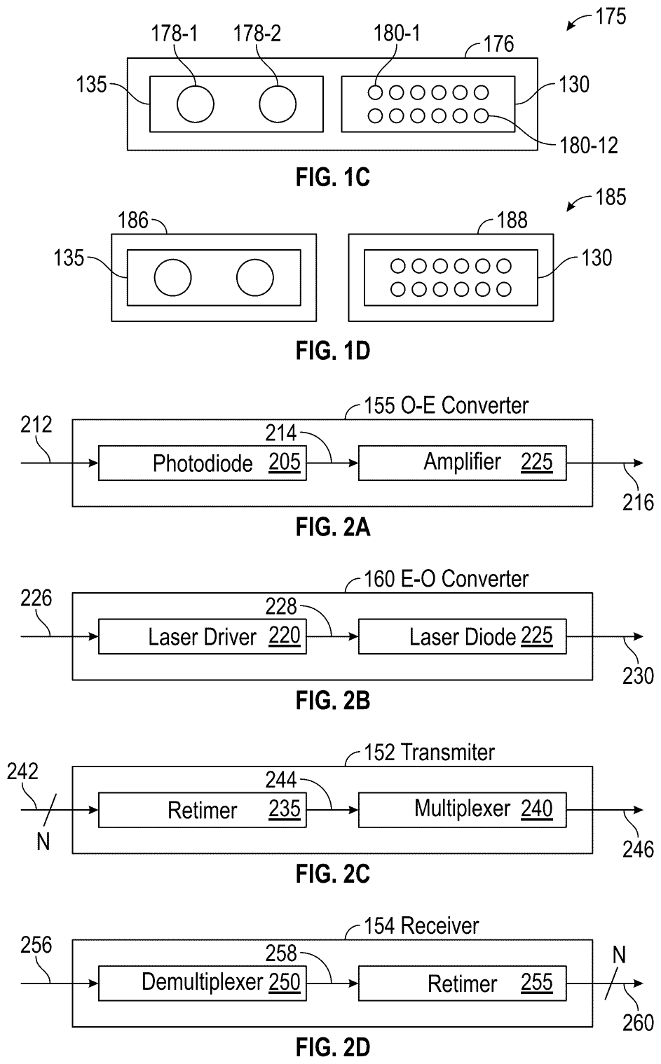

FIG. 1A illustrates an exemplary pluggable device 100 usable with a host network device, according to one or more embodiments. The pluggable device 100 comprises a housing 105 and a handle 110 that is coupled with, and that extends from, the housing 105. The pluggable device 100 further comprises various optical components and electronic components (not shown in FIG. 1A) within an interior volume of the housing 105. In some embodiments, the optical components and/or the electronic components of the pluggable device 100 are mounted on a printed circuit board (PCB) that is partly or fully enclosed by the housing 105.

The housing 105 may be formed of one or more housing components using any suitable materials. In some embodiments, the housing 105 comprises multiple walls and one or more removable covers, which collectively form the interior volume of the housing 105. In some embodiments, the housing 105 is formed of a metal or metal alloy that provides electromagnetic interference (EMI) shielding for the optical components and/or the electronic components. The handle 110 may be formed of any material(s) that are suitably rigid for manipulation of the pluggable device 100 by a user, such as a metal or plastic.

The pluggable device 100 (and more specifically, the housing 105) is dimensioned to be received into, and removed from, a receptacle (or socket) of the host network device. The form factor of the pluggable device 100 may be standardized (e.g., small form-factor pluggable (SFP), Quad SFP, Octal SFP, and so forth) or a proprietary form factor. In some embodiments, an external profile of the housing 105 is contoured to slidingly couple with portions of the receptacle, such that the receptacle guides the insertion of the pluggable device 100 (e.g., as a user manipulates the handle 110) into an inserted position in the host network device. In one example, the housing 105 has one or more external surfaces (e.g., planar surfaces) that slidingly couple with one or more internal surfaces (e.g., planar surfaces) of the receptacle. In another example, the receptacle includes one or more features (e.g., rails or grooves) that slidingly couple with one or more complementary features or external surfaces of the housing 105. Although not shown, the pluggable device 100 and/or the host network device may include one or more components for retaining the pluggable device 100 in the inserted position.

Referring also to FIG. 1B, which illustrates a block diagram 140 of the exemplary pluggable device 100 having a bidirectional optical-to-electrical-to-optical (O-E-O) converter 146 (also referred to herein as an O-E-O converter), an external optical interface 115 of the pluggable device 100 is arranged at a first end 144 of the housing 105. As shown, the handle 110 is arranged at, and extends from, the first end 144 of the housing 105. The external optical interface 115 may also be described as a “line-side” or “frontside” external optical interface 115 that supports coupling the optical components of the pluggable device 100 with a remote network device. As shown, the external optical interface 115 comprises two optical ports 125-1, 125-2, e.g., optical connectors that are dimensioned to connect with one or more connectorized optical cables. The two optical ports 125-1, 125-2 may be implemented with any suitable form factor, such as two Subscriber Connector (SC) connectors, two Lucent Connector (LC) connectors, a Multiple-Fiber Push-On (MPO) connector, and so forth. Different numbers of optical ports are also contemplated. Although not shown, the pluggable device 100 may include an external electrical interface and/or other ports at the first end 144 of the housing 105.

An external interface 120 of the pluggable device 100 is arranged at an opposing second end 142 of the housing 105 (that is, opposing the first end 144 of the housing 105). The external interface 120 may also be described as a “host-side” external interface 120 to be inserted into the receptacle of the host network device. In some embodiments, and as shown, the external interface 120 comprises a host-side external electrical interface 130 and a host-side external optical interface 135.

The host-side external electrical interface 130 and the host-side external optical interface 135 may be implemented in any suitable form. In some embodiments, and as shown in FIG. 1C, the host-side external electrical interface 130 and the host-side external optical interface 135 are included in a single host-side connector. More specifically, FIG. 1C provides an end view 175 of the single host-side connector, where the host-side external electrical interface 130 and the host-side external optical interface 135 are integrated in a single connector body 176. In some embodiments, and as shown in FIG. 1D, the host-side external electrical interface 130 and the host-side external optical interface 135 are included in separate host-side connectors. More specifically, FIG. 1D provides an end view 185 of the separate host-side connectors, where the host-side external electrical interface 130 is included in a first connector body 188, and the host-side external optical interface 135 is included in a second connector body 186. Although the host-side external electrical interface 130 and the host-side external optical interface 135 are shown in a side-by-side arrangement in FIGS. 1A, 1B, 1C, and 1D, other arrangements are also contemplated. In one example, the host-side external electrical interface 130 includes multiple sections that are spaced apart from each other, which in some cases may include the host-side external optical interface 135 interposed between the sections. In another example, the host-side external optical interface 135 includes multiple sections that are spaced apart from each other, which in some cases may include the host-side external electrical interface 130 interposed between the sections.

The host-side external electrical interface 130 defines one or more electrical pathways 180-1, 180-12 to electrical components and/or optical components of the pluggable device 100. In some embodiments, the electrical pathways 180-1, . . . , 180-12 comprise one or more conductive contacts, such as conductive pins or traces. The electrical pathways 180-1, . . . , 180-12 may carry power and/or control signals. In one example, the one or more conductive contacts comprise edge connector traces on the PCB of the pluggable device 100. The host-side external optical interface 135 defines one or more optical pathways 178-1, 178-2 to optical components of the pluggable device 100. Although two optical pathways 178-1, 178-2 are illustrated, any number of optical pathways are contemplated. In some embodiments, the optical pathways 178-1, 178-2 comprise one or more light-carrying media, such as optical fibers or waveguides, that are coupled with optical components of the pluggable device 100. For example, the one or more light-carrying media may include a plurality of parallel optical fibers that have a fixed arrangement provided by a fiber array unit (FAU). In some embodiments, the optical pathways 178-1, 178-2 comprise one or more free-space optical pathways.

When the pluggable device 100 is in an inserted position in the host network device, the external electrical interface 130 couples with a corresponding electrical interface of the host network device and the host-side external optical interface 135 couples with one or more optical components of the host network device (e.g., a corresponding optical interface of the host network device). More specifically, when the pluggable device 100 is in the inserted position, the conductive contacts of the external electrical interface 130 seat (or mate) with corresponding conductive contacts of the host network device (e.g., a socket that receives the edge connector traces) and the optical pathways of the host-side external optical interface 135 are aligned with optical components and/or light-carrying media of the host network device. In some embodiments, the optical pathways include optical connectors that mate with corresponding host-side optical connectors. In some embodiments, the optical pathways are side-coupled, edge-coupled, and so forth with corresponding light-carrying media of the host network device (e.g., optical fibers, waveguides of a photonic integrated circuit). In some embodiments, the pluggable device 100 may be contoured and/or the host network device may include guides or other features that gradually improve the alignment of the optical pathways of the host-side external optical interface 135 with the one or more optical components of the host network device as the pluggable device 100 is inserted toward the inserted position.

Returning to FIG. 1B, the O-E-O converter 146 is within the housing 105 and is coupled between the host-side external optical interface 135 and the line-side external optical interface 115. The O-E-O converter 146 comprises a controller 145, a transceiver 150, a plurality of optical-electrical (O-E) converters 155-1, 155-2, and a plurality of electrical-optical (E-O) converters 160-1, 160-2. Various components of the O-E-O converter 146 define a transmit path 147 and a receive path 148 through the O-E-O converter 146.

The transceiver 150 comprises a transmitter 152 and a receiver 154. The transmitter 152 comprises electronic transmitter circuitry (that is, operating in the electrical domain), and the receiver 154 comprises electronic receiver circuitry. Exemplary implementation details of the transmitter 152 and the receiver 154 are discussed below with respect to FIGS. 2C, 2D. In some embodiments, the circuitry of the transmitter 152 and the receiver 154 is integrated into an electronic IC (i.e., a single IC that includes all of the functionality of the transceiver 150). In other embodiments, the circuitry of the transmitter 152 and the receiver 154 is implemented as separate electronic integrated circuits (e.g., not implemented as an integrated transceiver 150).

The O-E-O converter 146 defines a transmit path 147 for transmitting data, received at the host-side external optical interface 135, to the line-side external optical interface 115. The transmit path 147 includes a first O-E converter 155-1 between the host-side external optical interface 135 and the transmitter 152, the transmitter 152, and a first E-O converter 160-2 between the transmitter 152 and the line-side external optical interface 115. In some embodiments, and as shown, the first O-E converter 155-1 comprises a first plurality of O-E converters 155-1, and the first E-O converter 160-2 comprises a first plurality of E-O converters 160-2, to support multiple physical communication lanes and greater throughput on the transmit path 147.

The O-E-O converter 146 further defines a receive path 148 for transmitting data, received at the line-side external optical interface 115, to the host-side external optical interface 135. The receive path 148 includes the receiver 154, a second O-E converter 155-2 between the line-side external optical interface 115 and the receiver 154, and a second E-O converter 160-1 between the receiver 154 and the host-side external optical interface 135. In some embodiments, the second O-E converter 155-2 comprises a second plurality of O-E converters 155-2, and the second E-O converter 160-1 comprises a second plurality of E-O converters 160-1, to support multiple physical communication lanes and greater throughput on the receive path 148.

Thus, along the transmit path 147, the O-E-O converter 146 may receive one or more optical signals from the host network device through the host-side external optical interface 135, convert the one or more optical signals using the first O-E converter(s) 155-1 into one or more electrical signals in the electrical domain, process the one or more electrical signals at the transmitter 152, convert the one or more processed electrical signals using the first E-O converter(s) 160-2 into one or more optical signals in the optical domain, and transmit the one or more optical signals to a remote network device through the line-side optical interface 115. To support greater optical transmission distances, the O-E-O converter 146 may output optical signals (e.g., the optical signals converted by the first E-O converter(s) 160-2) to the remote network device with greater optical powers, different wavelengths, and/or modulation formats than the optical signals received from the host network device.

Along the receive path 148, the O-E-O converter 146 may receive one or more optical signals from the remote network device through the line-side external optical interface 115, convert the one or more optical signals using the second O-E converter(s) 155-2 into one or more electrical signals in the electrical domain, process the one or more electrical signals at the receiver 154, convert the one or more processed electrical signals using the second E-O converter(s) 160-2 into one or more optical signals in the optical domain, and transmit the one or more optical signals to the host network device through the host-side optical interface 135. To support greater optical transmission distances, the O-E-O converter 146 may output optical signals (e.g., the optical signals converted by the second E-O converter(s) 155-2) to the host network device with reduced optical powers, different wavelengths, and/or modulation formats than the optical signals received from the remote network device.

FIG. 2A illustrates a block diagram of an exemplary O-E converter 155, according to one or more embodiments. The O-E converter 155 represents one example implementation of each of the first O-E converter(s) 155-1 and the second O-E converter(s) 155-2. The O-E converter 155 comprises optical and/or electronic circuitry that converts an optical signal 212 from the optical domain to the electrical domain. As shown, the O-E converter 155 comprises a photodiode 205 and an amplifier 210. The photodiode 205 receives the optical signal 212 and converts the optical signal 212 into an electrical signal 214. In some embodiments, the photodiode 205 comprises a semiconductor-based photodiode having any suitable implementation (e.g., a P-I-N photodiode, a P-N photodiode, or an avalanche photodiode). Other types of photodetectors are also contemplated. The amplifier 210 comprises electronic circuitry that amplifies the electrical signal 214 and provides an amplified electrical signal 216. The amplifier 210 may have any suitable implementation, which in some cases may include multiple stages of amplification. In one example implementation, the amplifier 210 includes a transimpedance amplifier stage and a limiting amplifier stage. Although not shown, the O-E converter 155 may perform other processing and/or signal conditioning in the optical domain and/or the electrical domain.

FIG. 2B illustrates a block diagram of an exemplary E-O converter 160, according to one or more embodiments. The E-O converter 160 represents one example implementation of each of the first E-O converter(s) 160-1 and the second E-O converter(s) 160-2. The E-O converter 160 comprises optical and/or electronic circuitry that converts an electrical signal 226 from the electrical domain to the optical domain. As shown, the E-O converter 160 comprises a laser driver 220 and a laser diode 225. The laser driver 220 may have any suitable implementation, such as a semiconductor-based device comprising a current source, a current-sense resistor, and an operational amplifier. The laser driver 220 receives an electrical (control) signal 226, which corresponds to the data of a desired output optical signal (which, in turn, may correspond to the data of an input optical signal). The electrical signal 226 controls the laser driver 220 to output an electrical drive signal 228. The electrical drive signal 228 drives the laser diode 225 to output the optical signal 230. The laser diode 225 may have any suitable implementation, such as a semiconductor-based laser diode.

Referring now to FIG. 1B, the transceiver 150 comprises electronic circuitry that receives and processes electrical signals, typically without altering the data included in the electrical signals. In the O-E-O converter 146, the transceiver 150 generally perform comparable (or complementary) functions on electrical signals on the transmit path 147 and on electrical signals on the receive path 148. In some embodiments, the transceiver 150 converts the wavelengths of the electrical signals (and optionally performs other processing of the electrical signals), which enables the relatively longer transmission distances such as intersite connections of 500 m to 2 km or more. For example, the wavelengths of the electrical signals may be adjusted to correspond to optical wavelengths that can propagate further for the particular transmission medium (e.g., an optical fiber), to correspond to a particular optical multiplexing scheme, and so forth.

FIG. 2C illustrates a block diagram of an exemplary transmitter 152, according to one or more embodiments. In some embodiments, the transmitter 152 is included in the transmit path 147 of the O-E-O converter 146. The transmitter 152 comprises a retimer 235 that receives N channels of electrical signals 242 (where N represents any positive integer), and outputs N channels of retimed electrical signals 244. The retimer 235 may have any suitable implementation, and generally includes clock and data recovery (CDR) circuitry that recovers data from the electrical signals 242 and extracts the embedded clock from the electrical signals 242. The retimer 235 further transmits the data from the electrical signals 242 with a new (or “clean”) clock signal as the retimed electrical signals 244. In some embodiments, the set of “clean” clock signals of the retimed electrical signals 244 differs from the set of embedded clock signals of the electrical signals 242, such that one or more of the retimed electrical signals 244 are transmitted on different wavelengths than the original electrical signals 242, which were produced by converting the optical signals received from the host network device.

In some embodiments, the transmitter 152 further comprises a multiplexer 240 that receives the N channels of retimed electrical signals 244 and outputs a multiplexed electrical signal 246. The multiplexer 240 may have any suitable multiplexing ratio. In one non-limiting example, the multiplexer 240 has a N:1 multiplexing ratio (that is, for N=4, the multiplexing ratio is 4:1).

In some embodiments, the transmitter 152 converts multiple channels of electrical signals 242 at one or more optical wavelengths (which in some cases may be a same wavelength), onto a single electrical signal with optical wavelengths corresponding to a wavelength-division multiplexing (WDM) scheme, such as coarse WDM (CWDM) or dense WDM (DWDM). The transmitter 152 may optionally perform other processing, such as converting the types of the electrical signals 242 (e.g., converting the electrical signals 242 corresponding to single-mode optical signals to a multiplexed electrical signal 246 corresponding to a multimode optical signal).

FIG. 2D illustrates a block diagram of an exemplary receiver 154, according to one or more embodiments. In some embodiments, the receiver 154 is included in the receive path 148 of the O-E-O converter 146. The receiver 154 comprises a demultiplexer 250 that receives an electrical signal 256 and outputs N channels of demultiplexed electrical signals 258. The demultiplexer 250 may have any suitable demultiplexing ratio. In one non-limiting example, the demultiplexer 250 has a 1:N demultiplexing ratio. In some embodiments, the demultiplexer 250 receives a single electrical signal having signal components at different wavelengths corresponding to an optical WDM scheme, and outputs the demultiplexed electrical signals 258 at the signal component wavelengths (which in some cases may be a same wavelength). The receiver 154 further comprises a retimer 255 that receives the demultiplexed electrical signals 258 and outputs N channels of retimed electrical signals 260. The operation of the retimer 255 may be comparable to the operation of the retimer 235.

Returning to FIG. 1B, electrical power and/or electrical signals may be transmitted through the host-side external electrical interface 130. As shown, the O-E-O converter 146 receives electrical power 165 and the controller 145 receives electrical power 166 from the host network device through the host-side external electrical interface 130. The controller 145 communicates electrical signals 170 with the O-E-O converter 146. In some embodiments, the controller 145 further communicates electrical signals 168 through the host-side external electrical interface 130.

The controller 145 comprises one or more processors having any suitable implementation, such as a microprocessor, controller, microcontroller, central processing unit (CPU), digital signal processor (DSP), application specific integrated circuit (ASIC), field programmable gate array (FPGA), other electronic circuitry, or a combination of one or more of the preceding. In some embodiments, the controller 145 is coupled to one or more machine-readable storage media (not shown) that stores code for execution on the one or more processors and/or to store data.

In some embodiments, the controller 145 is operable to access information fields (e.g., vendor information, identification information), to monitor operation of various components of the pluggable device (e.g., measuring operational parameters such as temperatures, voltages, received optical power, transmitted optical power), and to communicate control signals (e.g., power control, wavelength control). For example, the controller 145 may transmit the vendor information and the identification information through the host-side external electrical interface 130 to the network device. In some embodiments, the controller 145 comprises a memory coupled with the one or more processors that stores some or all of the information fields. For example, the memory may be a non-volatile memory such as an electrically erasable programmable read-only memory (EEPROM).

The controller 145 may implement a control algorithm that receives some or all of the measured operational parameters (which may include sensor measurements and/or receiving feedback signals of the electrical signals 170 from the O-E-O converter 146) and generates one or more control signals of the electrical signals 170 that are transmitted to the transceiver 150, the O-E converters 155, the E-O converters 160, and/or other components of the O-E-O converter 146. In some embodiments, the control algorithm may also receive one or more reference values and/or control signals from the network device (e.g., included in the electrical signals 168) that affect the generated one or more control signals. For example, the control algorithm may receive reference values from the host network device specifying an optical power of the optical signals to be output at the line-side external optical interface 115, the wavelengths of the optical signals, a multiplexing scheme, and so forth. Based on the reference values and/or the measured operational parameters, the controller 145 using the control algorithm generates control signals to control operation of the O-E-O converter 146 according to the reference values. Other control implementations are also contemplated. For example, the O-E-O converter 146 may receive control signals from, and/or transmit feedback signals to, the host device through the host-side external electrical interface 130.

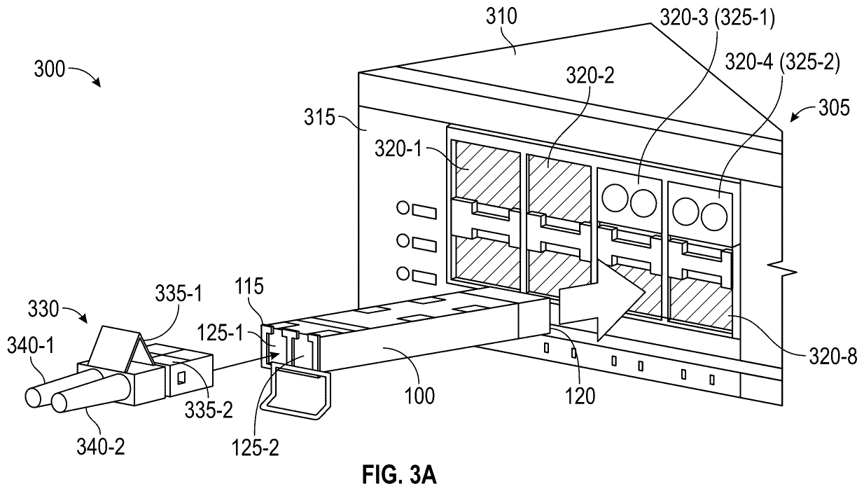

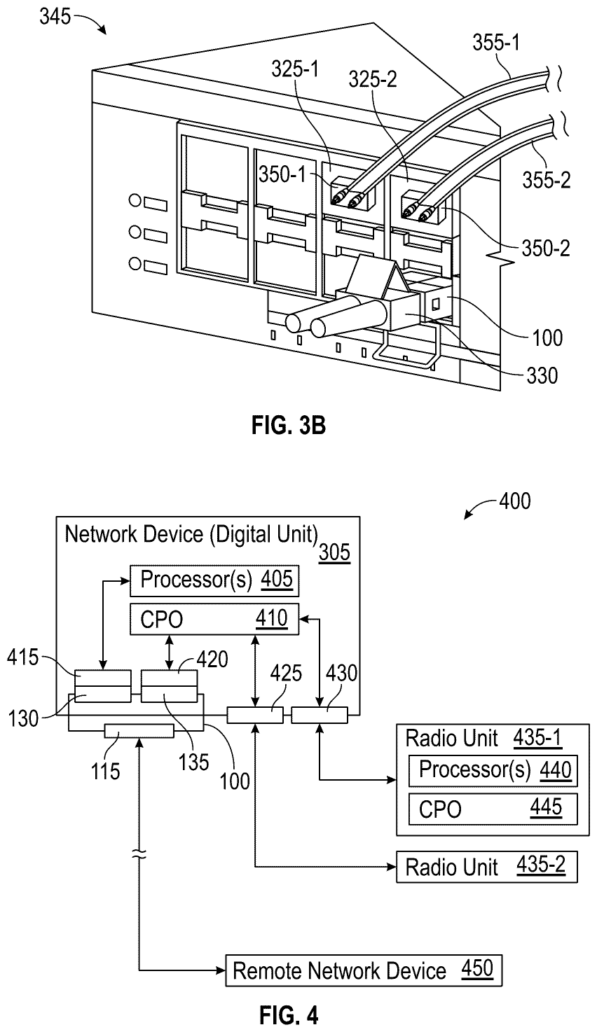

FIG. 3A is a diagram 300 that illustrates an exemplary network device 305 with an exemplary pluggable device 100 in an uninserted position, according to one or more embodiments. FIG. 3B is a diagram 345 that illustrates the network device 305 with the pluggable device 100 in the inserted position. The features illustrated in the diagrams 300, 345 may be used in conjunction with other embodiments discussed herein. For example, the network device 305 represents one example implementation of the host network device discussed above.

The network device 305 comprises a housing 310 defining an interior volume of the housing 310. In some embodiments, the housing 310 comprises a plurality of housing members that define a plurality of external surfaces of the housing 310. For example, the housing 310 may include a base, one or more sidewalls, and a lid that connect together to define the interior volume of the housing 310.

The network device 305 further defines a plurality of receptacles 320-1, 320-2, . . . , 320-8 extending from a surface 315 of the housing 310 (e.g., a front plate of the housing 310) into the interior volume of the housing 310. The receptacles 320-1, 320-2, . . . , 320-8 may have any suitable dimensioning, whether a standardized form factor (e.g., SFP, Quad SFP, Octal SFP, and so forth) or proprietary. The receptacles 320-1, 320-2, . . . , 320-8 support external connectivity to electronic and/or optical components of the network device 305 and housed in the housing 310. The supported external connectivity may be active (e.g., electrically-powered pluggable devices that are received into the receptacles 320-1, 320-2, . . . , 320-8) and/or passive (e.g., providing an electrical or optical pass-through for external cabling).

In the diagram 300, the receptacles 320-3, 320-4 include respective faceplates 325-1, 325-2 that provide passive optical connections to optical components of the network device 305 that are included in the housing 310. In some embodiments, and as shown in diagram 345 of FIG. 3B, each of the faceplates 325-1, 325-2 is dimensioned to receive a respective connector 350-1, 350-2 of a respective connectorized optical cable 355-1, 355-2. In some cases, each of the optical cables 355-1, 355-2 includes multiple single-mode optical fibers.

The host-side external interface 120 of the pluggable device 100 may be received into the receptacle 320-8, toward an inserted position in the network device 305 (illustrated in the diagram 345). In the inserted position, the host-side external electrical interface 130 of the pluggable device 100 couples with a corresponding electrical interface of the network device 305 and the host-side external optical interface 135 of the pluggable device 100 couples with one or more optical components of the network device 305.

An optical connector 330 of a connectorized optical cable may be received at the line-side external optical interface 115 of the pluggable device 100. As shown, the optical connector 330 comprises a SC or LC duplex connector, although other types of connectors are also contemplated (e.g., MPO). In the optical connector 330, jacketed optical fibers are received into respective connector bodies 340-1, 340-2 at one end of the optical connector 330, and are optically aligned by respective ferrules 335-1, 335-2 that extend to the opposing end of the optical connector 330. The ferrules 335-1, 335-2 are received into the respective optical ports 125-1, 125-2 when the optical connector 330 is attached to the pluggable device 100. The optical connector 330 may be retained by the pluggable device 100 at the line-side external optical interface 115.

FIG. 4 illustrates a block diagram 400 of an exemplary network device 305 coupled with a remote network device 450, according to one or more embodiments. The features in the block diagram 400 may be used in conjunction with other embodiments discussed herein. For example, the block diagram 400 represents one example implementation of the network device 305, where the pluggable device 100 is in the inserted position (as in FIG. 3B). In some embodiments, the block diagram 400 represents deployment of the network device 305 as a digital unit (DU) of a distributed RAN.

As used herein, a network device should be understood as an electronic device that communicatively interconnects other electronic devices on the network (e.g., other network devices, end-user devices). An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

As illustrated in FIG. 4, the network device 305 comprises one or more processors 405 (e.g., a host processor) having any suitable implementation, such as a microprocessor, controller, microcontroller, central processing unit (CPU), digital signal processor (DSP), application specific integrated circuit (ASIC), field programmable gate array (FPGA), other electronic circuitry, or a combination of one or more of the preceding. In some embodiments, the one or more processors 405 are coupled to one or more machine-readable storage media (not shown) that stores code for execution on the one or more processors and/or to store data.

In some embodiments, the one or more processors 405 comprises a host processor coupled with an electronic IC, which in some cases is packaged with (and coupled with) co-packaged optics (CPO) 410. The host processor and/or the electronic IC are coupled with an electrical interface 415, which is coupled with the host-side external electrical interface 130 of the pluggable device 100 when the pluggable device 100 is in the inserted position. The CPO 410 is optically coupled with an optical interface 420, which is coupled with the host-side external optical interface 135 of the pluggable device 100 when the pluggable device 100 is in the inserted position. In alternate embodiments, the network device 305 may include one or more optical components, such as a photonic IC, that are coupled with the one or more processors 405 but are not co-packaged with a dedicated electronic IC.

The CPO 410 is coupled with external optical interfaces 425, 430 of the network device 305 that connect to respective radio units (RUs) 435-2, 435-1. In some embodiments, the external optical interfaces 425, 430 comprise the faceplates 325-1, 325-2 shown in FIGS. 3A, 3B, and are connected to the RUs 435-2, 435-1 using respective connectorized cables (e.g., patch cords).

Although the network device 305 is illustrated with the optical interface 420 and the external optical interfaces 425, 430, it will be understood that in some embodiments, all of the optical interfaces to the CPO 410 are accessible through respective receptacles and may have a similar configuration, such that any of the optical interfaces may be coupled with a pluggable device 100 or with a connectorized cable. In this way, the deployment of the network device 305 may be tailored to include a desired number of pluggable devices 100 at desired receptacles.

Each RU 435-2, 435-1 comprises one or more processors 440 and an external optical interface. In some embodiments, the RUs 435-2, 435-1 include CPO 445 that are electrically coupled with the one or more processors 440 and that are optically coupled with the external optical interface. In some embodiments, the RUs 435-2, 435-1 may include one or more pluggable devices at the external optical interface.

In some embodiments, each of the RUs 435-2, 435-1 is considered to be at a same site as the network device 305. As described herein, the “same site” indicates a distance of less than 500 m between the network device 305 and the respective RU 435-2, 435-1.

The network device 305 is coupled with a remote network device 450 through the line-side external optical interface 115 of the pluggable device. In some embodiments, a connectorized cable connects the line-side external optical interface 115 with the remote network device 450. In some embodiments, the remote network device 450 is considered to be at a different site (remote) as the network device 305. As described herein, “different sites” indicates a distance of 500 m-2 km or more.

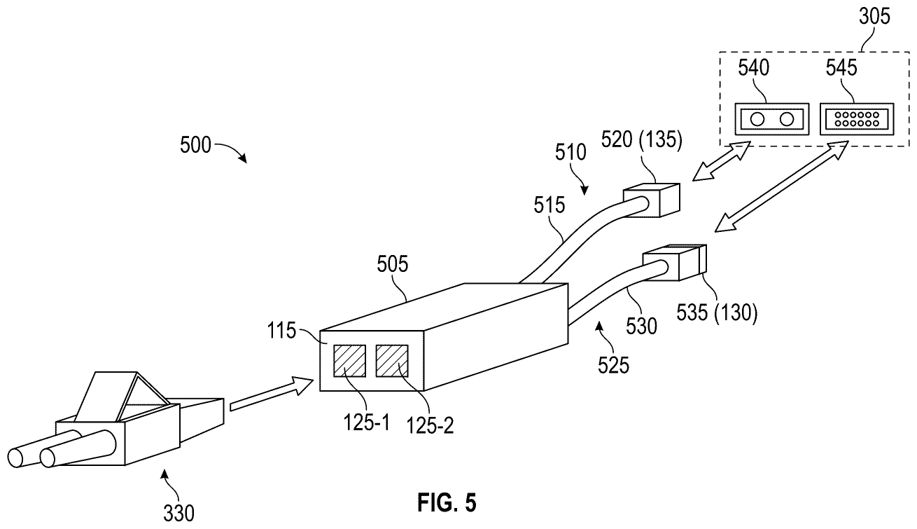

FIG. 5 illustrates an exemplary optical device 500 having a pigtail extending to a host-side external interface, according to one or more embodiments. The features in FIG. 5 may be used in conjunction with other embodiments discussed herein. The optical device 500 generally represents an alternate implementation of the pluggable device 100 of FIG. 1A and includes features comparable to the pluggable device 100.

The optical device 500 comprises a housing 505 and various optical components and electronic components within an interior volume of the housing 505. In some embodiments, the optical device 500 comprises, within the interior volume of the housing 505, the controller 145 and O-E-O converter 146 that are illustrated in FIG. 1B.

The optical device 500 further comprises the external optical interface 115 (here, comprising the optical ports 125-1, 125-2) at a first end of the housing 505, and pigtails 510, 525 extending from an opposing second end of the housing 505. The pigtail 510 comprises an optical cable 515, and an optical connector 520 that is coupled to the optical cable 515 and that provides the host-side external optical interface 135 for the optical device 500. The pigtail 525 comprises an electrical cable 530, and an electrical connector 535 that is coupled to the electrical cable 530 and that provides the host-side external electrical interface 130 for the optical device 500. The optical connector 520 and the electrical connector 535 may have any suitable implementation, whether including standardized form factors and/or proprietary form factors. The pigtails 510, 525 may have any suitable lengths consistent with the optical device 500 being at a same site as the network device 305, and the lengths are typically significantly less than the distance limit for intrasite communications. In some embodiments, the pigtails 510, 525 are less than 1 m, e.g., between about 5 centimeters (cm) and about 30 cm, such that the optical device 500 may be implemented as a dongle for the network device 305.

The optical connector 520 connects to a corresponding optical connector 540 of the network device 305, and the electrical connector 535 connects to a corresponding electrical connector 545 of the network device 305. The network device 305 may be configured to include the optical connector 540 and the electrical connector 545 as passive connectors in respective faceplates.

Although shown as separate pigtails 510, 525, one alternate implementation of the optical device 500 may include a single pigtail that incorporates the optical fiber(s) of the optical cable 515 and the electrical conductor(s) of the electrical cable 530 into a single cable, and that includes an integrated connector (e.g., integrated in a single connector body 176 as in FIG. 1C) connected to the single cable. Another alternate implementation of the optical device 500 may include the optical cable 515 and the electrical cable 530 separately, that are connected with an integrated connector.

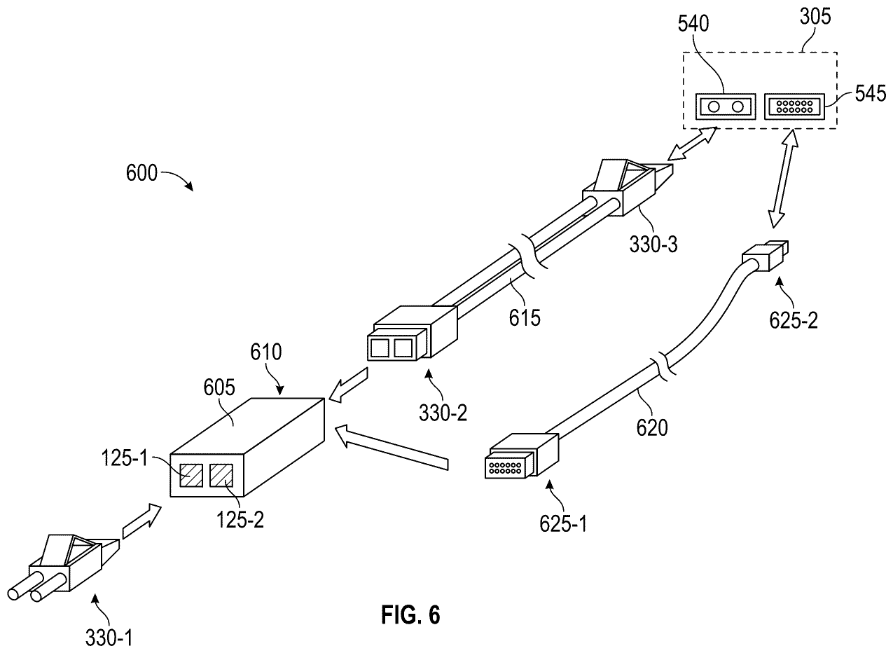

FIG. 6 illustrates an exemplary optical device 600 using connectorized optical cables to couple with a network device, according to one or more embodiments. The features in FIG. 6 may be used in conjunction with other embodiments discussed herein. The optical device 600 generally represents an alternate implementation of the pluggable device 100 of FIG. 1A and includes features comparable to the pluggable device 100.

The optical device 600 comprises a housing 605 and various optical components and electronic components within an interior volume of the housing 605. In some embodiments, the optical device 600 comprises, within the interior volume of the housing 605, the controller 145 and O-E-O converter 146 that are illustrated in FIG. 1B.

The optical device 600 further comprises the external optical interface 115 (here, comprising the optical ports 125-1, 125-2) at a first end of the housing 605, and a second external interface 610 at an opposing second end of the housing 605. The second external interface 610 includes one or more optical ports and one or more electrical ports at the second end. In some cases, the optical ports of the second external interface 610 may have the same form factor as the optical ports 125-1, 125-2.

A connectorized optical cable 615 has, at a first end, a first optical connector 330-2 that connects to the optical port(s) of the second external interface 610. The connectorized optical cable 615 has, an opposing second end, a second optical connector 330-3 that connects to the optical connector 540 of the network device 305. A connectorized electrical cable 620 has, at a first end, a first electrical connector 625-1 that connects to the electrical port(s) of the second external interface 610. The connectorized electrical cable 620 has, an opposing second end, a second electrical connector 625-2 that connects to the electrical connector 545 of the network device 305.

The optical connectors 330-2, 330-3 and the electrical connectors 625-1, 625-2 may have any suitable implementation, whether including standardized form factors and/or proprietary form factors. The optical device 600 may have any suitable dimensioning, and in some embodiments may be small enough to be considered an optical adapter between optical cables. For example, the housing 605 may have outer dimensions that are each less than about 15 cm (e.g., about 5 cm height×5 cm width×10 cm length). Although described as having separate optical port(s) and electrical port(s) at the second external interface 610, one alternate implementation of the optical device 600 may include an integrated connector (e.g., integrated in a single connector body 176 as in FIG. 1C).

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A pluggable device usable with a host network device, the pluggable device comprising:
a housing;
a host-side external optical interface at a first end of the housing to be removably inserted into a receptacle of the host network device, wherein when the first end of the housing is in an inserted position, the host-side external optical interface is optically coupled with one or more optical components of the host network device;
a line-side external optical interface at an opposing second end of the housing;
a bidirectional optical-to-electrical-to-optical (O-E-O) converter within the housing, the O-E-O converter coupled between the host-side external optical interface and the line-side external optical interface; and
a host-side external electrical interface at the first end of the housing, wherein when the first end of the housing is in the inserted position, the O-E-O converter receives electrical power from the host network device via the host-side external electrical interface.

2. The pluggable device of claim 1, wherein the O-E-O converter defines:
a transmit path comprising:
a transmitter comprising electronic circuitry;
a first optical-to-electrical (O-E) converter between the host-side external optical interface and the transmitter; and
a first electrical-to-optical (E-O) converter between the transmitter and the line-side external optical interface; and
a receive path comprising:
a receiver comprising electronic circuitry;
a second O-E converter between the line-side external optical interface and the receiver; and
a second E-O converter between the receiver and the host-side external optical interface.

3. The pluggable device of claim 1,
wherein when the first end of the housing is in the inserted position, the host-side external optical interface is electrically coupled with one or more electrical components of the host network device.

4. The pluggable device of claim 3, wherein the host-side external optical interface and the host-side external electrical interface are integrated in a single host-side connector.

5. The pluggable device of claim 1, wherein the one or more optical components of the host network device comprise co-packaged optics.

6. The pluggable device of claim 5, wherein the pluggable device supports a connection from the co-packaged optics of the host network device, through the O-E-O converter and the line-side external optical interface, to a remote network device of 500 meters or more without an external transponder interposed between the pluggable device and the remote network device.

7. The pluggable device of claim 2,
wherein the host-side external optical interface is configured to connect with the host network device via a first plurality of light-carrying media,
wherein the first O-E converter comprises:
a plurality of photodiodes corresponding to the first plurality of light-carrying media; and
amplifier circuitry between the plurality of photodiodes and the transmitter.

8. The pluggable device of claim 2,
wherein the host-side external optical interface is further configured to connect with the host network device via a second plurality of light-carrying media,
wherein the second E-O converter comprises:
a plurality of laser diodes corresponding to the second plurality of light-carrying media; and
laser driver circuitry between the receiver and the plurality of laser diodes.

9. An optical device usable with a host network device, the optical device comprising:
a body;
a host-side external interface to the body, the host-side external interface comprising:
a first external optical interface to couple with a first plurality of light-carrying media of the host network device; and
an external electrical interface;
a line-side external interface to the body, the line-side external interface comprising:
a second external optical interface to couple with a remote network device via one or more light-carrying media; and
a bidirectional optical-to-electrical-to-optical (O-E-O) converter within the body and coupled between the first external optical interface and the second external optical interface, the O-E-O converter to receive electrical power from the host network device via the external electrical interface.

10. The optical device of claim 9, wherein the O-E-O converter comprises:
a transceiver comprising electronic circuitry to receive electrical power from the host network device via the external electrical interface;
a plurality of optical-to-electrical (O-E) converters within the body, wherein the plurality of O-E converters comprises a respective O-E converter between the transceiver and each of the first external optical interface and the second external optical interface; and
a plurality of electrical-to-optical (E-O) converters within the body, wherein the plurality of E-O converters comprises a respective E-O converter between the transceiver and each of the first external optical interface and the second external optical interface.

11. The optical device of claim 9, wherein the first external optical interface and the external electrical interface are included in separate host-side connectors.

12. The optical device of claim 9, wherein the first external optical interface and the external electrical interface are integrated in a single host-side connector.

13. The optical device of claim 9, further comprising:
a pigtail extending from the body to the host-side external interface.

14. The optical device of claim 13, wherein the body is contoured to receive a connectorized optical cable at the second external optical interface.

15. The optical device of claim 9, wherein the body is contoured to receive a first connectorized optical cable at the first external optical interface, and to receive a second connectorized optical cable at the second external optical interface.

16. The optical device of claim 9, wherein the first plurality of light-carrying media are coupled with co-packaged optics of the host network device.

17. The optical device of claim 16, wherein the optical device supports a connection from the co-packaged optics of the host network device, through the O-E-O converter and the second external optical interface, to the remote network device of 500 meters or more without an external transponder interposed between the optical device and the remote network device.

18. A network device comprising:
a housing defining an interior volume;
a plurality of receptacles extending from a surface of the housing into the interior volume;
a plurality of host electrical connectors arranged at the plurality of receptacles; and
one or more host optical connectors arranged at one or more optical-enabled receptacles of the plurality of receptacles,
wherein when a first type of pluggable device is received into an inserted position in any of the plurality of receptacles, an electrical connector of the first type of pluggable device is electrically coupled with a corresponding host electrical connector of the plurality of host electrical connectors;
wherein when a second type of pluggable device is received into the inserted position in any of the one or more optical-enabled receptacles: (1) an electrical connector (130) of the second type of pluggable device is electrically coupled with a corresponding host electrical connector of the plurality of host electrical connectors such that the network device provides electrical power to the second type of pluggable device, and (2) an optical connector of the second type of pluggable device is optically coupled with a corresponding host optical connector of the one or more host optical connectors.

19. The network device of claim 18, wherein the second type of pluggable device comprises a bidirectional optical-to-electrical-to-optical (O-E-O) converter coupled between the optical connector and a line-side external optical interface, the O-E-O converter to receive the electrical power from the network device via the host electrical connector.

20. The network device of claim 19, further comprising:
co-packaged optics optically coupled with the one or more host optical connectors, wherein the second type of pluggable device supports a connection from the co-packaged optics, through the O-E-O converter and the line-side external optical interface, to a remote network device of 500 meters or more without an external transponder interposed between the optical device and the remote network device.
